(19) United States
(12) Patent Application Publication
(10) Pub. No.: US 2003/0004737 A1
(43) Pub. Date: Jan. 2, 2003

(54) Automated product registration

(76) Inventors: Christopher S. Conquest, Richmond, VA (US); Perry M. Pascual, Richmond, VA (US); Vincent R. Shavers, Glen Allen, VA (US); James Stiebel, Glen Allen, VA (US)

Correspondence Address: BAKER & MCKENZIE, 805 THIRD AVENUE, NEW YORK, NY, 10022, US

(21) Appl. No.: 09/896,042

(22) Filed: Jun. 29, 2001

(51) Int. Cl. G06F 17/60

(52) U.S. Cl. 705/1

(57) ABSTRACT

System and method for registering a product on behalf of a purchaser who purchases a product from a vendor using a financial instrument such as a credit card. In one embodiment, the system collects product information at a point of sale. The system collects purchaser information from the financial institution that issued the instrument to the purchaser. The collected purchase and purchaser information are then forwarded to the manufacturer or its authorized agent for registration, e.g., to facilitate development of cross-selling opportunities, to activate a manufacturer'warranty or to obtain a rebate, upgrades or recall information and transmitting information to the purchaser confirming the product registration.

### FIELD

The present application relates to an information processing system, and more particularly to a method and system for registering product purchases with a manufacturer, manufacturer representative, vendor or other entity using information obtained at the point of purchase.

### BACKGROUND

The registration of a purchased product is often necessary to take advantage of services offered by or on behalf of the manufacturer or vendor of the product. For instance, products often must be registered to take advantage of a manufacturer'rebate and to activate a manufacturer's warranty.

In addition, product registration can present the manufacturer or third party with additional sales opportunities and demographic data on the customer. For instance, if a manufacturer has information about the purchasers of its products it can direct its advertisements for related products and services specifically to the purchaser. Thus, manufacturers and vendors can use customer information to advertise and to offer discounts, coupons for accessory products or product upgrades.

Ordinarily, the purchaser manually registers the product by filling out a card with the required information and mailing it to the manufacturer or other designated entity. This process takes time and purchasers do not always go to the trouble to fill out the cards. It is not uncommon with regard to warranty cards, for example, that by the time the purchaser gets around to filling out the card, the purchaser has misplaced the sales receipt or has forgotten purchase information that the manufacturer has requested on the warranty card. In addition, the use of a warranty card requires that the manufacturer employ personnel to receive the warranty cards and to key in the information contained on them.

Some manufacturers have offered on-line warranty registration over the Internet. However, even on-line registration requires that the purchaser take the trouble to visit the manufacturer's web site, to find the appropriate web page and to enter the required information on the web page. Some purchasers never go to the trouble of registering their purchases, sometimes forfeiting the opportunity to activate the manufacturer's warranty.

The process of obtaining a manufacturer's rebate on a purchase similarly requires that the purchaser fill out and mail in an information form. In addition, in order to receive a rebate manufacturers commonly require that the purchaser provide proof of purchase information, such as a UPC code and a sales receipt. However, purchasers often lose or misplace their sales receipts, fail to take the time to fill out the forms or simply forget to apply for the rebate.

There is a need for an improved method and system for registering product purchases for purposes of product warranty, rebate, upgrades, recalls, cross-selling and the like.

### SUMMARY OF THE INVENTION

An aspect of the present application provides a computer-implemented method of registering a product on behalf of a purchaser who purchases the product using a financial instrument, such as a credit card, debit card or smart card. The method comprises receiving from a vendor purchase information for the product purchased by the purchaser, the purchase information including a purchase date and a product identifier, receiving from the vendor an identifier of the financial instrument, for instance, a credit card account number, that the purchaser used to purchase the product, retrieving information of the purchaser from a financial institution that issued the financial instrument and transmitting the purchase information and the purchaser information to a manufacturer of the product for registration of the product.

Another aspect of the present application provides a method for registering a product for warranty service. The method includes obtaining product information, purchase information and customer information electronically from the vendor, using the information to obtain additional information about the product purchased, the purchaser, and the manufacturer or other entity to which the information is to be provided, formatting the information if it is not received in a pre-formatted state pursuant to the requirements of the manufacturer or other entity that is to receive the warranty information, providing the warranty information to the manufacturer or other entities, receiving a confirmation that the product has been registered for warranty purposes and sending a warranty registration confirmation to the purchaser.

A further aspect of the present application provides a method for obtaining a rebate on a product on behalf of a purchaser of the product. The method includes obtaining product information, purchase information and customer information electronically from the vendor, using the information to obtain additional information about the product purchased, the purchaser, the vendor, the manufacturer or other entity to which the information is to be provided, formatting the information if it is not received in a pre-formatted state pursuant to the requirements of the manufacturer or other entity that is to receive the rebate information, providing the rebate information to the vendor, manufacturer or other entity, receiving a confirmation that the rebate information has been received by the manufacturer or other entity and sending a rebate registration confirmation to the purchaser. An extension of this aspect of the present application provides a method by which a purchaser may obtain a rebate at the point of sale.

A further aspect of the invention extends to a scenario in which a vendor serves as a controller, or a manufacturer serves as a vendor and/or controller.

### BRIEF DESCRIPTION OF THE DRAWINGS

FIG. 1a illustrates an exemplary embodiment for obtaining and providing information concerning a product purchase to a manufacturer, vendor or other entity to develop cross-selling opportunities;

FIG. 1b provides a more detailed illustration of a portion of the embodiment illustrated in FIG. 1a;

FIG. 2a illustrates an exemplary embodiment for obtaining and providing information to register a product to activate the product warranty;

FIG. 2b provides a more detailed illustration of a portion of the embodiment illustrated in FIG. 2a;

FIG. 3a illustrates an exemplary embodiment for obtaining information for requesting a product rebate;

FIG. 3b provides a more detailed illustration of a portion of the embodiment illustrated in FIG. 3a;and

FIG. 4 illustrates an exemplary system of the present application.

### DETAILED DESCRIPTION

The present invention is a method by which an entity, such as a credit card issuer, can provide purchase and purchaser information to a manufacturer for various purposes, including to facilitate upgrades, recalls, cross-selling of related products, activation of manufacturer warranties, and rebates.

In the ordinary retail transaction made with a credit card, the purchaser chooses a product to purchase and presents the product to the vendor at the point of sale. Generally, the vendor scans the product's UPC code and swipes the purchaser's credit card. The vendor then transmits to a transaction authorizing party information concerning the product and manufacturer, such as the product's UPC code, information concerning the transaction, such as the vendor's identification and location, the date of purchase and the transaction amount and information concerning the purchaser, such as the purchaser's name, credit card number and the credit card expiration date.

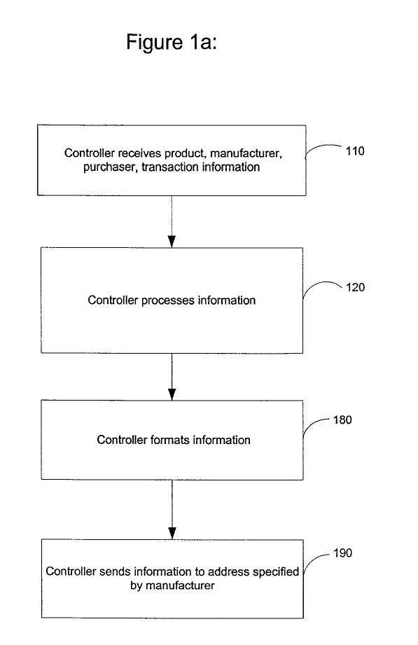

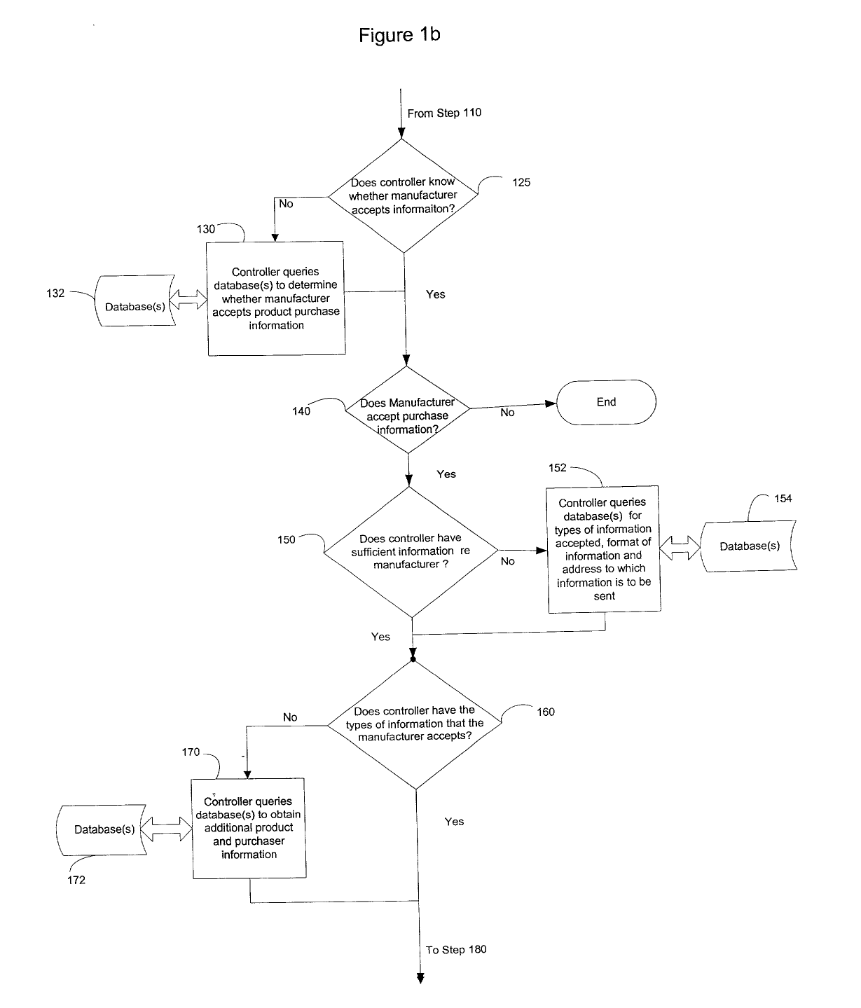

FIG. 1a illustrates a method 100 for providing product purchase information to a manufacturer where one or more items of the information provided to the manufacturer comes from the point of sale, either directly, or indirectly through an authorizing agent or other entity. Although the embodiment illustrated in FIG. 1a refers to a “manufacturer” as the ultimate recipient of the information, the information collected and can be provided to entities other than the manufacturer.

The steps involved in providing product purchase information to a manufacturer in the present invention are illustrated in FIG. 1a. In step 110, the controller, which may be the credit card issuer or another entity, receives manufacturer information, product information, purchase information and purchaser information from the vendor, the authorizing agent or from another entity.

The vendor may collect product information by various means including scanning the product's universal product code. The term “universal product code” is used to indicate standardized industry codes used to designate goods made or sold in commerce and includes the Universal Product Codes (“UPC” code) used by manufacturers, wholesalers and vendors in the United States and Canada, the EAN codes used by manufacturers, wholesalers and vendors outside the United States and Canada, and any other codes used by groups of manufacturers, wholesalers and vendors to identify products. The present invention is not limited to use with products manufactured or packaged with UPC codes, but may be used with any system of marking a product with an identifier, by way of example, a radio frequency identification (“RFID”) tag.

The purchase information includes the date of purchase, which the vendor may obtain by keying in the date of purchase, by obtaining the date of purchase from an electronic source or by any other means of obtaining the purchase date. The purchase information may include the price of the product, which may be keyed into a cash register, obtained from a database using the UPC code obtained from the product, or any other means of obtaining the product's price.

Purchaser information is obtained by swiping the customer's credit card through a card reader that reads information from the magnetic strip on the card and processes the information from the magnetic strip through techniques well known in the art. Although the exemplary embodiment refers to a “credit card”, the present invention is not limited to a credit card. Rather, the vendor may swipe a debit card or other card containing a purchaser identifier in machine readable form, read a smart card or key in, or have the purchaser key in, an account number assigned to the purchaser as opposed to swiping a credit card.

The manufacturer information includes a manufacturer identifier such as a UPC code. However, the manufacturer information may also include other information including information as to whether the manufacturer accepts information on transactions involving the product, the items of information the manufacturer accepts, the format the information should be in and an electronic or geographic address to which the information should be transmitted.

In step 120, the controller processes the information obtained in step 110. FIG. 1b contains a more detailed illustration of step 120. In step 125, the controller determines whether it has received information in step 110 as to whether the manufacturer accepts transaction information such as product, purchase and purchaser information. Some manufacturers may not gather information on sales of their products. Moreover, some manufacturers may gather information on only a subset of products that they manufacture.

If the manufacturer information received in step 110 does not indicate whether the manufacturer accepts information on transactions involving the product, in step 130 the controller queries a database using the manufacturer identifier and product identifier received in step 110 to obtain information as to whether the manufacturer accepts information concerning the transaction. In step 140, the controller determines whether the manufacturer accepts purchase information for the purchased product. If the manufacturer does not accept such information, no further action would be performed with regard to that purchased product.

If the manufacturer accepts information concerning the transaction, in step 150 the controller determines whether it has sufficient manufacturer information to complete the process, such as the types of information the manufacturer accepts, the format the information should be in and the address to which the information should be sent. If the controller does not have all of the manufacturer information, the controller queries a database for the missing information in step 152. In the preferred embodiment a single manufacturer database contains all of the information needed from the manufacturer. However, the present invention includes a method and system in which the controller must query more than one database to obtain the manufacturer information.

Once the controller has the information as to the types of information the manufacturer accepts, in step 160 the controller determines whether it obtained all of that information in step 110. If it does not have any particular item of information requested by the manufacturer, in step 170 the controller queries one or more appropriate databases for the missing information. For example, if the manufacturer requests that the information transmitted include the product model number, the controller would obtain the model number from a database containing product model numbers using the UPC code. Thus, in step 120, the controller obtains all of the additional information that the manufacturer requests and that the controller has ready access to.

Referring back to FIG. 1a, in step 180, the controller then formats the product, purchase and purchaser information in the manner desired by the manufacturer.

In step 190, the controller transmits the information that the controller has obtained and that the manufacturer has requested to the address specified by the manufacturer.

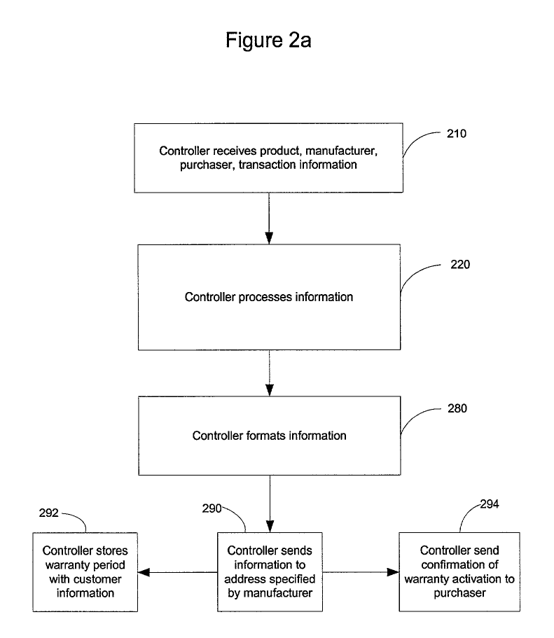

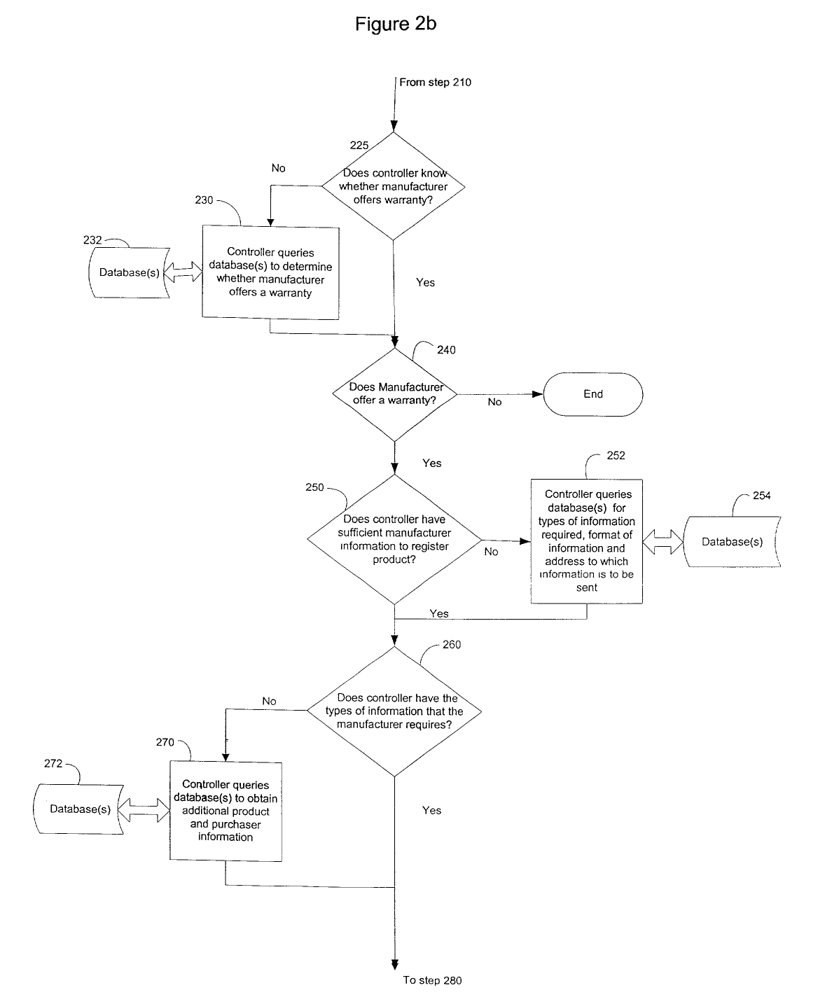

As is illustrated in FIG. 2a, the present invention can be used to register a product purchase to activate a product warranty. In step 210, the controller receives manufacturer information, product information, purchase information and purchaser information from the vendor, the authorizing agent or from another party.

In step 220, the controller processes the information obtained in step 210 and gathers additional warranty information if it does not have all of the information that the manufacturer requests for warranty activation. FIG. 2b contains a more detailed illustration of step 220. In step 225, the controller determines whether the information received in step 210 includes information as to whether the manufacturer offers a warranty on the purchased product.

If the manufacturer information received in step 210 does not include information as to whether the manufacturer offers a product warranty on the purchased product, in step 230 the controller queries a database using the manufacturer identifier and product identifier received in step 210 to obtain information as to whether the manufacturer offers a warranty on the purchased product. The controller then assesses in step 240 the information that it has to determine whether the manufacturer offers a warranty on the product. If the manufacturer does not offer a warranty on the product, no further action would be performed with regard to that product.

If the manufacturer offers a warranty on the product, in step 250 the controller determines whether it has sufficient manufacturer information, such as the types of information the manufacturer requires for warranty activation, the format the information should be in and the address to which the information should be sent. If the controller does not have all of the manufacturer information, in step 252 the controller queries one or more appropriate databases for the missing information. Once the controller has the information as to the types of information the manufacturer requires for warranty activation, in step 260 the controller determines whether it has that information. If it does not have any particular item of information, in step 270 the controller queries one or more appropriate databases for the information. Thus, in step 270 the controller obtains all of the additional warranty information that it has ready access to.

Referring back to FIG. 2a, in step 280, the controller then formats the product, purchase and purchaser information that the manufacturer requires in the manner desired by the manufacturer.

In step 290, the controller transmits the warranty information to the address specified by the manufacturer.

In step 292, the controller stores the warranty information with the purchaser information.

In step 294, the controller sends the purchaser confirmation that the warranty information has been forwarded to the manufacturer, and information as to the length of the warranty and the warranty terms.

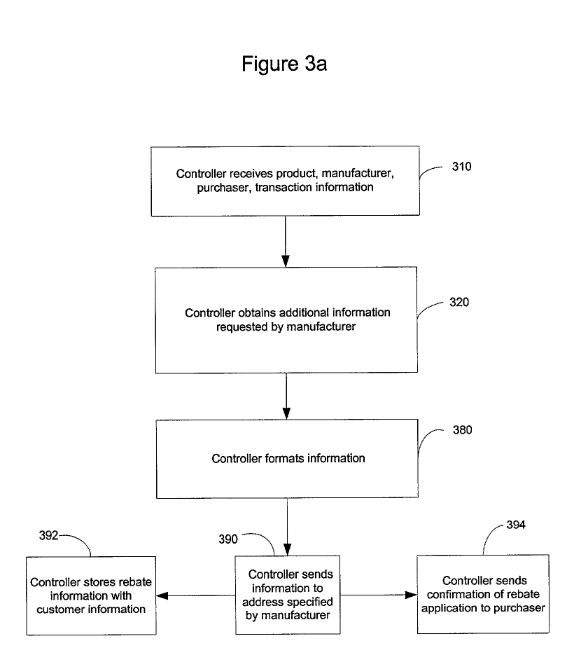

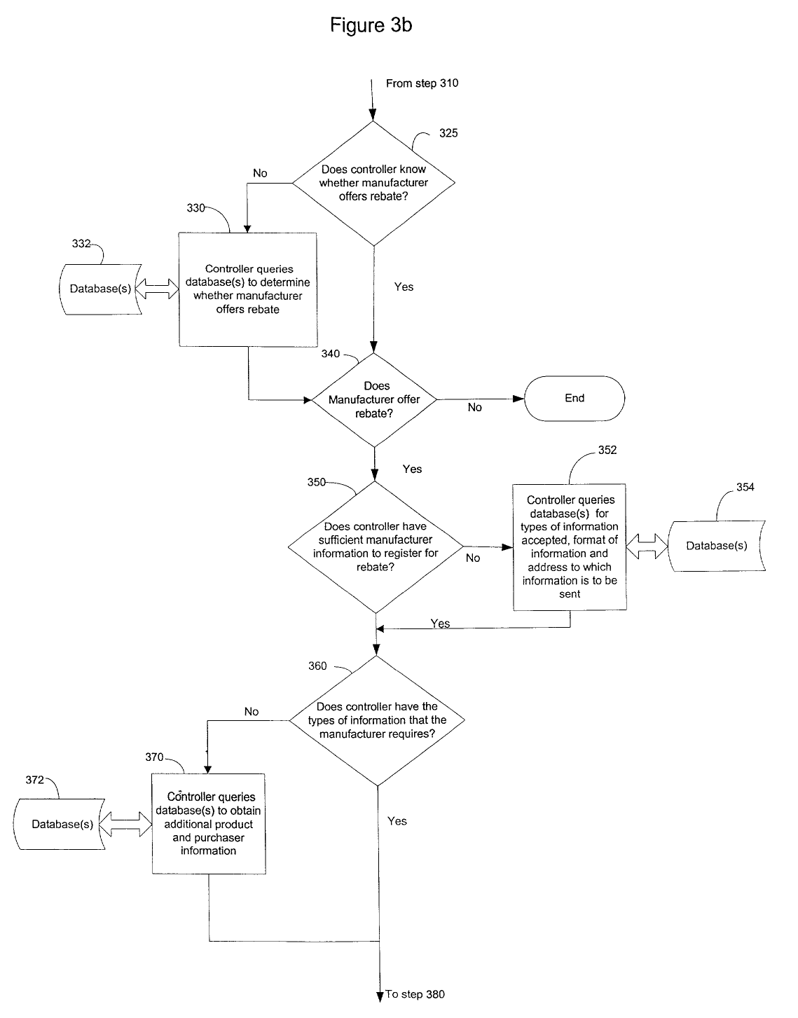

As is illustrated in FIG. 3a, the present invention can be used to apply for a manufacturer rebate on a purchased product. In step 310, the controller, which may be the credit card issuer or another party, receives manufacturer information, product information, purchase information and purchaser information from the vendor, the authorizing agent or from another party.

In step 320, the controller processes the information received in step 310 and gathers additional rebate information if necessary. FIG. 3b contains a more detailed illustration of step 320. In step 325, the controller determines whether the information received in step 310 includes information as to whether the manufacturer offers a rebate on the purchased product.

If the manufacturer information received in step 310 does not include information as to whether the manufacturer offers a rebate on the purchased product, in step 330 the controller queries a database using the manufacturer identifier and product identifier received in step 310 to obtain information as to whether the manufacturer offers a rebate on the purchased product. In step 340 the controller assesses the information that it has to determine whether the manufacturer offers a rebate on the product. If the manufacturer does not offer a rebate on the product, no further action would be performed with regard to that product.

If the manufacturer offers a rebate on the product, in step 350 the controller determines whether it has sufficient manufacturer information, such as the types of information the manufacturer requires for the rebate, the format the information should be in and the address to which the information should be sent. If the controller does not have all of the manufacturer information, in step 352 the controller queries one or more databases for the missing information. Once the controller has the information as to the types of information the manufacturer requires for the rebate, in step 360 the controller determines whether it has that information. If it does not have any particular item of information, in step 370 the controller queries one or more appropriate databases for the missing information.

Referring back to FIG. 3a, in step 380, the controller formats in the manner desired by the manufacturer the product, purchase and purchaser information that the manufacturer requires for a rebate application and that the controller has been able to obtain.

In step 390, the controller transmits the rebate information to the address specified by the manufacturer.

In step 392, the controller stores the rebate information with the purchaser information.

In step 394, the controller sends the purchaser confirmation that the rebate information has been forwarded to the manufacturer.

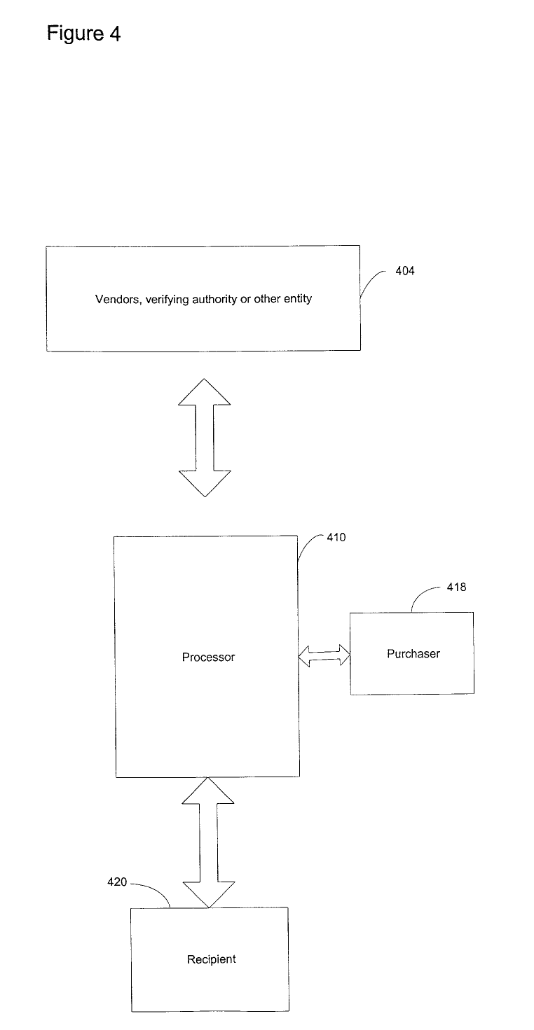

FIG. 4 illustrates an embodiment of a business system according to the present invention. In FIG. 4, processor 410 is electronically connected to a plurality of vendors, either directly or indirectly through an intermediary entity, such as a credit card authorizing agent, a credit card issuer or other entity 404. Processor 410 is programmable to receive product information, manufacturer information, purchase information and purchaser information from the vendors or other entities. Processor 410 may be a personal computer, a server, a mainframe or a network including computers, or any other processing and/or storage devices.

Processor 410 is electronically connected to a Recipient 420. Processor 410 is programmable to transmit product information, manufacturer information, purchase information and purchaser information to Recipient 420. Recipient 420 may be a personal computer, server, mainframe or network including computers, or any other processing and/or storage devices operated by a manufacturer or other entity designated by a manufacturer to receive one or more of product information, manufacturer information, purchase information and purchaser information.

Processor 410 is electronically connected to one or more databases (not shown) that contain one or more of product information, manufacturer information, purchase information and purchaser information.

Processor 410 is electronically connected to one or more databases (not shown) for storing product information, manufacturer information, purchase information and purchaser information.

Processor 410 is programmable to transmit information to the purchaser, including confirmation that information has been sent to Recipient 420. Processor 410 may interface with the purchaser electronically through a network such as the Internet, or by other electronic means, through devices such as a personal computer, personal digital assistant (PDA), other forms of electronic wallet, telephone, mobile phone, server, mainframe or network of computers, or some other similar device operated by the purchaser. Such information may be sent electronically through a network such as the Internet. Alternatively, Processor 410 may alert a person to send a hard copy of the information to the purchaser.

The embodiments described above are illustrative examples of the present invention and it should not be construed that the present invention is limited to these particular embodiments. Various changes and modifications may be effected by one skilled in the art without departing from the spirit or scope of the invention as defined in the appended claims. The components of the embodiments illustrated in FIGS. 1a-4 may be implemented through hardware, software, and/or firmware. The number of components in FIGS. 1a-4 is not limited to what is illustrated. Accordingly, the present invention is not limited except as by the appended claims.

We claim:

1. A computer-implemented method of registering a product on behalf of a purchaser who purchases the product from a vendor using a financial instrument, comprising:
receiving from the vendor purchase data for the product purchased by the purchaser, the purchase data including a purchase date and a product identifier;
receiving from the vendor an identifier of the financial instrument that is used to purchase the product by the purchaser;
retrieving data of the purchaser according to the financial instrument identifier; and
transmitting the purchase data and the purchaser data to a manufacturer of the product on behalf of the purchaser for registration of the product.

2. The method as set forth in claim 1 wherein the financial instrument is a credit or charge card and the step of retrieving data of the purchaser includes:
querying a database maintained by the financial institution using the financial instrument identifier; and
receiving the purchaser data from the database.

3. The method as set forth in claim 1 wherein the financial instrument can be a credit or charge card, smart card, personal digital assistant, mobile phone or wireless device.

4. The method as set forth in claim 1, further comprising the step of transmitting confirmation of the product registration to the purchaser.

5. The method as set forth in claim 1, further comprising:
obtaining, from the manufacturer, product warranty information that indicates the data elements that are required for registration of the product for warranty;
assembling the data elements from the purchase data and the purchaser data according to the obtained product warranty information; and
transmitting the assembled data elements to the manufacturer for warranty registration.

6. The method as set forth in claim 1, further comprising:
obtaining, from the manufacturer, a warranty term of the product; and
transmitting an extended warranty offer to the purchaser prior to expiration of the warranty term.

7. The method as set forth in claim 1, further comprising:
obtaining, from the manufacturer, rebate information pertaining to the product; and
providing a rebate to the purchaser.

8. The method as set forth in claim 1, further comprising:
obtaining one or more product items that are related to the product purchased; and
marketing the product items to the purchaser.

9. The method as set forth in claim 1, further comprising:
obtaining information regarding a recall of the product purchased; and
transmitting the product recall information to the purchaser.

10. A method for registering a purchased product, comprising:
obtaining purchase information transmitted electronically by the vendor, the purchase information including a date of purchase;
obtaining information concerning the product purchased, the product information including a product identifier;
obtaining information concerning the purchaser of the product, the purchaser information including a purchaser identifier;
obtaining information concerning the manufacturer of the product, the manufacturer information including a manufacturer identifier;
providing any one or more items of the obtained purchase information, product information, purchaser information and manufacturer information to a registrar.

11. The method as set forth in claim 10, wherein the step of obtaining information concerning the product purchased comprises scanning the product's UPC code or reading the product's RFID tag.

12. The method as set forth in claim 10, wherein the step of obtaining information concerning the product purchased comprises the steps of:
obtaining a product identifier by scanning the product's UPC code or reading the product's RFID tag; and
obtaining at least one additional item of product information from a database of information by using the obtained product identifier.

13. The method as set forth in claim 10, wherein at least one item of the purchaser information is obtained from a card having a magnetic strip.

14. The method as set forth in claim 10, wherein the step of obtaining purchaser information comprises the steps of:
obtaining a purchaser identifier from a card having a magnetic strip; and,
obtaining at least one item of additional purchaser information from a database of information by using the obtained purchaser identifier.

15. The method as set forth in claim 10, wherein the financial instrument is a smart card and at least one item of the purchaser information is obtained by reading information from the smart card.

16. The method as set forth in claim 10, wherein at least one item of the manufacturer information is obtained by scanning the product's UPC code.

17. The method as set forth in claim 10, wherein at least one item of the manufacturer information is obtained by reading the product's RFID tag.

18. The method as set forth in claim 10, wherein the step of obtaining manufacturer information comprises the steps of:
obtaining a manufacturer identifier by scanning the product's UPC code or reading the product's RFID tag; and
obtaining at least one additional item of manufacturer information from a database of information by using the obtained manufacturer identifier.

19. The method as set forth in claim 10 wherein the step of obtaining product information comprises the steps of:
obtaining an email address for the purchaser;
sending an email message to the purchaser requesting additional product information; and
receiving an email message from the purchaser containing the additional product information.

20. The method as set forth in claim 10 further comprising the steps of:
receiving confirmation of the product registration from the registrar; and,
forwarding confirmation of the product registration to the purchaser.

21. A system for registering a purchased product using information obtained electronically at a point of sale, comprising:
a processor electronically connected to a plurality of vendor devices, the processor further electronically connected to a plurality of recipients, the processor programmable to receive product information, manufacturer information, purchase information and purchaser information, the processor programmable to transmit product information, purchase information and purchaser information to one or more recipients; and,
a database containing purchaser information, the database electronically connected to the processor; and
a database containing one or more of manufacturer information and product information, the database electronically connected to the processor.

22. The system of claim 21 wherein the database containing one or more of manufacturer information and product information is comprised of:
a database containing manufacturer information.

23. The system of claim 21 further comprising a database for storing information comprising manufacturer information, product information, purchase information and purchaser information.

24. The system of claim 21 wherein the processor is electronically connected to a purchaser device over a network.

25. A system for registering a purchased product using information obtained electronically at a point of sale, comprising:
a processor; and
a registration program controlling the processor, and operable to:
receive from a vendor device purchase data for the product purchased by the purchaser, the purchase data including a purchase date and a product identifier;
receive from a vendor device an identifier of a financial instrument that is used a purchaser to purchase a product;
retrieve data of the purchaser from a financial institution that issued the financial instrument; and
transmit the purchase data and the purchaser data to a recipient.

26. The system as set forth in claim 25 wherein the financial instrument is a credit card and the registration program is further operable to:
query a database maintained by the financial institution using the financial instrument identifier; and
receive the purchaser data from the database.

27. The system as set forth in claim 25, wherein the registration program is further operable to:
obtain from the manufacturer product warranty information that indicates the data elements that are required for registration of the product for warranty;
assemble the data elements from the purchase data and the purchaser data according to the obtained product warranty information; and
transmit the assembled data elements to the manufacturer for warranty registration.

28. The system as set forth in claim 25, wherein the registration program is further operable to:
obtain from the manufacturer a warranty term of the product; and
send an extended warranty offer to the purchaser prior to expiration of the warranty term.

29. The system as set forth in claim 27, wherein the registration program is further operable to:
obtain from the manufacturer rebate information pertaining to the product; and
it provide a rebate to the purchaser.

30. The system as set forth in claim 27, wherein the registration program is further operable to:
obtain one or more product items that are related to the product purchased; and
send to the purchaser an offer for the product items.
